(19) United States
(12) Patent Application Publication
(10) Pub. No.: US 2024/0176292 A1
(43) Pub. Date: May 30, 2024

(54) HOLOGRAPHIC DISPLAY OF CONTENT BASED ON VISIBILITY

(71) Applicant: INTERNATIONAL BUSINESS MACHINES CORPORATION, ARMONK, NY (US)

(72) Inventors: Michael Boone, Lutz, FL (US); Jeremy R. Fox, Georgetown, TX (US); Tushar Agrawal, West Fargo, ND (US); Sarbajit K. Rakshit, Kolkata (IN)

(21) Appl. No.: 18/058,923

(22) Filed: Nov. 28, 2022

(51) Int. Cl. G03H 1/04; G03H 1/00; G03H 1/08

(52) U.S. Cl. CPC G03H 1/0486; G03H 1/0005; G03H 1/08; G03H 2001/0061; G03H 2210/20; G03H 2210/32; G03H 2226/05

(57) ABSTRACT

Aspects of the present disclosure relate to holographic display of content based on visibility. Low visibility of a 2-dimensional (2D) display with respect to a user can be detected. In response to detecting the low visibility, holographic content display characteristics of holographic content to be generated from the 2D display can be determined. Based on the determined holographic content display characteristics, holographic content can be generated via a holographic display of the 2D display.

### BACKGROUND

The present disclosure relates generally to the field of computing, and in particular, to holographic display of content based on visibility.

A holographic display is a type of display that utilizes light physics (e.g., interference and diffraction) to create virtual 3-dimensional (3D) images. Holographic displays differ from other forms of 3D displays in that they do not require the aid of any external equipment (e.g., augmented reality (AR) or virtual reality (VR) headsets) for a viewer to see the image.

### SUMMARY

Aspects of the present disclosure relate to a computer program product, system, and method for holographic display of content based on visibility. Low visibility of a 2-dimensional (2D) display with respect to a user can be detected. In response to detecting the low visibility, holographic content display characteristics of holographic content to be generated from the 2D display can be determined. Based on the determined holographic content display characteristics, holographic content can be generated via a holographic display of the 2D display.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a high-level block diagram illustrating an example computer system and network environment that can be used in implementing one or more of the methods, tools, modules, and any related functions described herein, in accordance with embodiments of the present disclosure.

FIG. 2 is block diagram illustrating an example network environment, in accordance with embodiments of the present disclosure.

FIG. 3 is a block diagram illustrating an example network environment including a holographic display management system, in accordance with embodiments of the present disclosure.

FIG. 4 is a flow-diagram illustrating an example method for holographic display management, in accordance with embodiments of the present disclosure.

FIG. 5 is a diagram illustrating a scenario in which holographic display management based on visibility is implemented, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of computing, and in particular, to holographic display of content based on visibility. While the present disclosure is not necessarily limited to such applications, various aspects of the disclosure may be appreciated through a discussion of various examples using this context.

As previously described, holographic displays utilize light physics (e.g., interference and diffraction) to generate virtual 3-dimensional (3D) images. Holographic displays differ from other forms of 3D displays in that they do not require the aid of any external equipment (e.g., VR or AR headsets) for a viewer to see the image. Display devices (e.g., smart phones, smart televisions, etc.) increasingly include capabilities to create mid-air holographic objects through holographic projectors installed in the devices. These projectors can project holographic objects mid-air above the surface of the display device to create a three-dimensional (3D) view of the displayed content.

Various environments include 2-dimensional (2D) displays that are positioned to show important information to nearby individuals. The 2D displays can depict alerts (e.g., traffic accidents, road work conditions, etc.), plans (e.g., flight delays), weather, or any other type of information. 2D digital displays are commonly set up in areas where their view may become obstructed, such as outside during foggy conditions or in crowded indoor environments (e.g., an airport). As such, individuals that are intended to see information displayed on a 2D display may be unable to. Improvements are needed in the field of display technology to address such circumstances.

Aspects of the present disclosure relate to holographic display of content based on visibility. Low visibility of a 2-dimensional (2D) display with respect to a user can be detected. In response to detecting the low visibility, holographic content display characteristics (e.g., light physics requirements, light intensity, hologram size, hologram orientation, hologram position, etc.) of holographic content to be generated from the 2D display can be determined. Based on the determined holographic content display characteristics, holographic content can be generated via a holographic display of the 2D display.

Aspects of the present disclosure improve display technology. By using low visibility of a 2D display as a condition for generating holographic content, if a user is unable to see a 2D display, they may resume viewing the content formerly displayed on the 2D display via the generated 3D holographic content. This can enable a user to view potentially important content (e.g., content related to user safety or time-sensitive content) if current environmental conditions do not allow the user to see the content via the 2D display.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

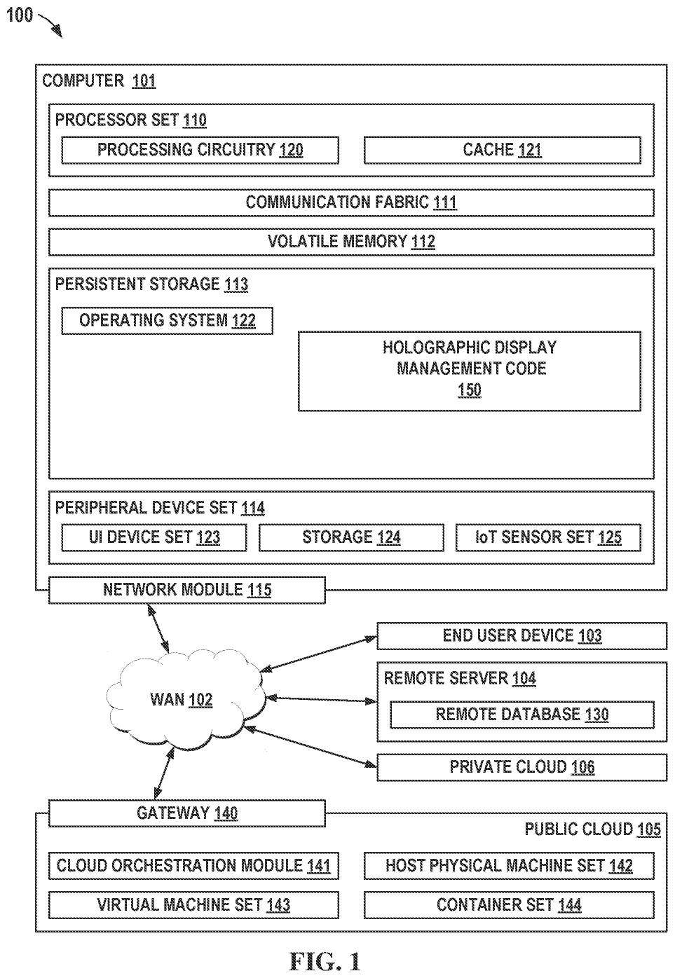

FIG. 1 is a high-level block diagram illustrating an example computing environment 100 that can be used in implementing one or more of the methods, tools, modules, and any related functions described herein, in accordance with embodiments of the present disclosure. Computing environment 100 contains an example of an environment for the execution of at least some of the computer code involved in performing the inventive methods, such as holographic display management code 150. In addition, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and holographic display management code 150, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some or all of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in holographic display management code 150 in persistent storage 113.

Communication fabric 111 includes the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in holographic display management code 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, mixed reality (MR) headset, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

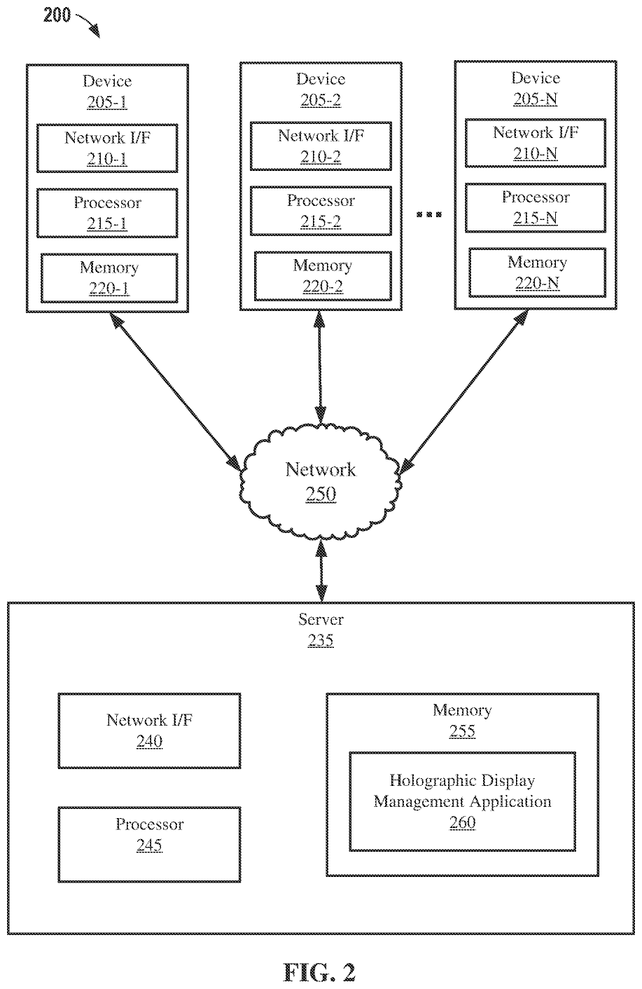

FIG. 2 is a block diagram illustrating an example computing environment 200 in which illustrative embodiments of the present disclosure can be implemented. Computing environment 200 includes a plurality of devices 205-1, 205-2 . . . 205-N (collectively devices 205), at least one server 235, and a network 250.

The devices 205 and the server 235 include one or more processors 215-1, 215-2, . . . , 215-N (collectively processors 215) and 245 and one or more memories 220-1, 220-2, . . . , 220-N (collectively memories 220) and 255, respectively. The processors 215 and 245 can be same as, or substantially similar to, processor set 110 of FIG. 1. The memories 220 and 255 can be the same as, or substantially similar to volatile memory 112 and/or persistent storage 113 of FIG. 1.

The devices 205 and the server 235 can be configured to communicate with each other through internal or external network interfaces 210-1, 210-2 . . . 210-N (collectively network interfaces 210) and 240. The network interfaces 210 and 240 are, in some embodiments, modems or network interface cards. The network interfaces 210 and 240 can be the same as, or substantially similar to, network module 115 described with respect to FIG. 1.

The devices 205 and/or the server 235 can be equipped with a display or monitor. Additionally, the devices 205 and/or the server 235 can include optional input devices (e.g., a holographic display, keyboard, mouse, scanner, biometric scanner, video camera, or other input device), and/or any commercially available or custom software (e.g., holographic content generation software, web conference software, browser software, communications software, server software, natural language processing software, search engine and/or web crawling software, image processing software, etc.). For example, devices 205 and/or server 235 can include components/devices such as those described with respect to peripheral device set 114 of FIG. 1. The devices 205 and/or the server 235 can be servers, desktops, laptops, or hand-held devices. The devices 205 can include holographic projectors/devices capable of generating holograms depicting 3D digital content mid-air. The devices 205 and/or the server 235 can be the same as, or substantially similar to, computer 101, remote server 104, and/or end user device 103 described with respect to FIG. 1.

The devices 205 and the server 235 can be distant from each other and communicate over a network 250. In some embodiments, the server 235 can be a central hub from which devices 205 can establish a communication connection, such as in a client-server networking model. Alternatively, the server 235 and devices 205 can be configured in any other suitable networking relationship (e.g., in a peer-to-peer (P2P) configuration or using any other network topology).

In some embodiments, the network 250 can be implemented using any number of any suitable communications media. In embodiments, the network 250 can be the same as, or substantially similar to, WAN 102 described with respect to FIG. 1. For example, the network 250 can be a wide area network (WAN), a local area network (LAN), an internet, or an intranet. In certain embodiments, the devices 205 and the server 235 can be local to each other and communicate via any appropriate local communication medium. For example, the devices 205 and the server 235 can communicate using a local area network (LAN), one or more hardwire connections, a wireless link or router, or an intranet. In some embodiments, the devices 205 and the server 235 can be communicatively coupled using a combination of one or more networks and/or one or more local connections. For example, the first device 205-1 can be hardwired to the server 235 (e.g., connected with an Ethernet cable) while the second device 205-2 can communicate with the server 235 using the network 250 (e.g., over the Internet).

In some embodiments, the network 250 is implemented within a cloud computing environment or using one or more cloud computing services. Consistent with various embodiments, a cloud computing environment can include a network-based, distributed data processing system that provides one or more cloud computing services. Further, a cloud computing environment can include many computers (e.g., hundreds or thousands of computers or more) disposed within one or more data centers and configured to share resources over the network 250. In embodiments, network 250 can be coupled with public cloud 105 and/or private cloud 106 described with respect to FIG. 1.

The server 235 includes a holographic display management application (HDMA) 260. The HDMA 260 can be configured to generate holographic content (e.g., 3-dimensional (3D) holograms) in response to determining low visibility (e.g., a low visibility condition, visibility below a visibility threshold, etc.) of a 2-dimensional (2D) display with respect to a user. The generated holographic content can mirror content which is displayed on the 2D display such that the user can resume view of the content displayed on the 2D display via the generated holographic content.

The HDMA 260 can be configured to monitor visibility of a 2D display (e.g., a 2D digital display) with respect to one or more users. Monitoring visibility can include collecting sensor data (“visibility data”) from one or more sensors within the environment of the 2D display. These sensors can include, among others, sensors integrated within the 2D display, surrounding internet of things (IOT) sensors (e.g., environmental optical sensors), and sensors associated with the one or more users (e.g., cameras on mobile devices or extended reality (XR) devices) within the environment of the 2D display. The sensors can include optical sensors (e.g., light-based sensors such as fog detectors, visibility detectors, cameras, gaze-tracking sensors, etc.) configured to determine a level of visibility of the 2D display with respect to the one or more users. The optical sensors can capture visibility data (e.g., visibility factors) including the field of view (FoV) of users, the distance between the users and the 2D display, the level of visibility in the air (e.g., fog/dust concentration), obstructions blocking view of the 2D display, environmental light conditions (e.g., ambient light), and viewing angle, among other visibility data.

The HDMA 260 can be configured to determine whether low visibility (e.g., a low visibility condition) of the 2D display exists with respect to a user. Determining that low visibility exists can include analyzing the collected visibility data to determine that visibility is low (e.g., below a threshold visibility) for the user. Determining low visibility can include a collective analysis of the collected visibility data with respect to the user's point of view. For example, analyzing the visibility data can include analyzing the FoV of the user, the distance between the user and the 2D display, the level of visibility in the air (e.g., fog/dust concentration) in the environment of the user, obstructions to the user blocking view of the 2D display, light conditions in the environment of the user, and viewing angle of the user. A collective analysis of the above visibility factors can be used to determine whether visibility is low or acceptable. However, in embodiments, one or more of the above visibility factors can be considered to determine whether visibility is low (a collective analysis is not required, and may only consider a subset of the visibility factors).

The HDMA 260 can monitor visibility over any suitable time period (e.g., continuously, intermittently, periodically, etc.). If low visibility is not detected with respect to a user, then the HDMA 260 can continue to monitor visibility until low visibility is detected. If low visibility is detected with respect to a user, then the HDMA 260 can be configured to determine holographic content display characteristics of holographic content to be generated from a holographic display (e.g., a holographic projector) of the 2D display device. The holographic content display characteristics can include, among others, light physics characteristics (e.g., waveform characteristics facilitating generation of interference patterns on a physical medium (air)), light intensity, hologram position, hologram orientation, and hologram size. The holographic content display characteristics can be determined based on the collected visibility data including the FoV of the user, the distance between the user and the 2D display, the level of visibility in the air (e.g., fog/dust concentration) in the environment of the user, obstructions to the user blocking view of the 2D display, light conditions in the environment of the user, and viewing angle of the user. Thus, the visibility data may be used not only to indicate visibility conditions of 2D digital display with respect to the user, but to determine characteristics of the hologram to be generated. For example, the holographic content display characteristics can differ based on FoV, distance, level of visibility in the air, environmental light, and/or viewing angle. Accordingly, the holographic content to be displayed can be personalized based on the user's point of view. The holographic content to be displayed can mirror the 2D content which is displayed on the 2D display. Thus, the holographic content characteristics can alter the properties of the content displayed in 2D on the 2D display upon projection via holography via a holographic display.

Upon determining holographic content display characteristics of the holographic content to be generated, the HDMA 260 can be configured to instruct (e.g., command, issue instructions to, etc.) a holographic display of the 2D display to generate the holographic content based on the determined holographic content display characteristics. Thus, the content which was previously displayed on the 2D digital displayed (e.g., text, diagrams, symbols, avatars, images, etc.) can now be displayed in 3D in-air using holography. This can allow the user to view the content even in the low visibility environment.

In some embodiments, artificial intelligence/machine learning (AI/ML) algorithms can be used to determine low visibility conditions based on collected visibility data and/or to determine holographic content display characteristics based on collected visibility data. AI/ML algorithms that can be used to determine low visibility conditions based on collected visibility data and/or to determine holographic content display characteristics based on collected visibility data include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques. Any of the data discussed with respect to HDMA 260, HDMS 305 (discussed below), and/or datastore 380 (discussed below) can be analyzed or utilized as training data using any of the aforementioned machine learning algorithms. For example, historically collected visibility data can be used to train one or more AI/ML algorithms to determine low visibility conditions and/or to determine holographic content display characteristics.

More specifically, the AI/ML algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other techniques.

It is noted that FIG. 2 is intended to depict the representative major components of an example computing environment 200. In some embodiments, however, individual components can have greater or lesser complexity than as represented in FIG. 2, components other than or in addition to those shown in FIG. 2 can be present, and the number, type, and configuration of such components can vary.

While FIG. 2 illustrates a computing environment 200 with a single server 235, suitable computing environments for implementing embodiments of this disclosure can include any number of servers. The various models, modules, systems, and components illustrated in FIG. 2 can exist, if at all, across a plurality of servers and devices. For example, some embodiments can include two servers. The two servers can be communicatively coupled using any suitable communications connection (e.g., using a WAN 102, a LAN, a wired connection, an intranet, or the Internet).

Though this disclosure pertains to the collection of personal data (e.g., visibility data collected by one or more sensors), it is noted that in embodiments, users opt into the system. In doing so, they are informed of what data is collected and how it will be used, that any collected personal data may be encrypted while being used, that the users can opt-out at any time, and that if they opt out, any personal data of the user is deleted.

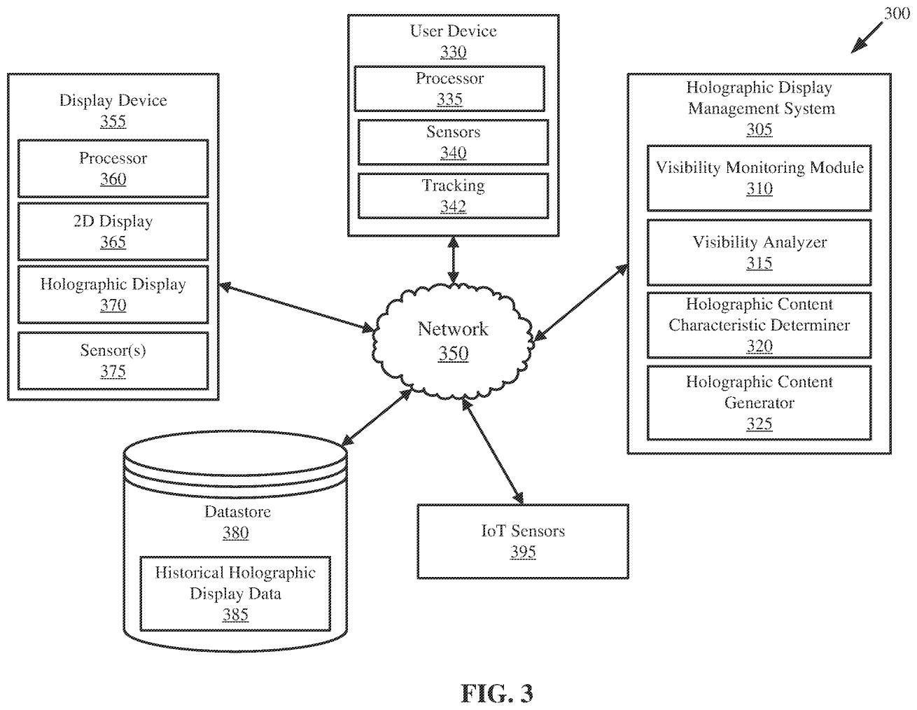

Referring now to FIG. 3, shown is a block diagram illustrating an example network environment 300 in which illustrative embodiments of the present disclosure can be implemented. The network environment 300 includes a holographic display management system (HDMS) 305, a user device 330, a display device 355, a datastore 380, and IoT sensors 395, each of which can be communicatively coupled for intercomponent interaction via a network 350. In embodiments, the network 350 can be the same as, or substantially similar to, network 250 and/or WAN 102. In embodiments, the user device 330, display device 355, IoT sensors 395, and HDMS 305 can be the same as, or substantially similar to, computer 101, devices 205, and/or server 235.

The user device 330 can be a personal user device (e.g., smart phone, augmented reality (AR) device, virtual reality (VR) device, tablet, computer 101, device 205, etc.) which can interface with the HDMS 305. The user device 330 includes a processor 335, sensors 340 (e.g., optical sensors), and tracking 342 (e.g., position, orientation, and gaze tracking). In embodiments, tracking 342 can include receiving a gazed image (e.g., detected by eye tracking cameras) on which tracked eyes are fixed and determining coordinates of an axis of a line-of-sight, also referred to as a sightline or visual axis, the user is viewing within the field of view captured by the tracking 342. Sensors 340 and/or tracking 342 can be used to determine a field of view (FoV) of a user, viewing distance of a user with respect to an object (e.g., a 2D digital display), position of a user, and viewing angle of a user with respect to an object (e.g., a 2D digital display). Data collected by sensors 340 and/or tracking 342 can be used as visibility data for determining visibility conditions and/or holographic content display characteristics.

In embodiments, the user device 330 can enable the user to interface (e.g., control, manage, view, etc.) the HDMS 305. For example, an application (e.g., HDMA 260) which allows the user to change configuration settings of functionalities of the HDMS 305 can be installed on the user device 330. This can allow the user to define data collection limitations (e.g., the type of visibility data that can be collected and the manners in which visibility data can be used/analyzed), set holographic content display characteristic preferences (e.g., hologram size preferences, hologram color preferences, hologram font characteristics, etc.), and set visibility thresholds (e.g., conditions/thresholds which dictate “low visibility”), among other configurable settings.

The display device 355 includes a processor 360, a 2D display 365, a holographic display 370, and sensors 375. The display device 355 can be a device which is designated to display informational content within a given environment. For example, the display device 355 can be digital traffic signage, a flight information display system, a digital billboard or advertisement, or any other suitable digital display. The 2D display 365 can be a screen which displays digital content in a 2-dimensional manner, such as a liquid-crystal display (LCD) or a light-emitting diode (LED) display. Any suitable 2D display technology known in the art can be implemented without departing from the spirit and scope of the present disclosure.

The holographic display 370 can include various components which facilitate generation of holographic images (e.g., holograms, holographic content, etc.) mid-air. The holographic display 370 can include one or more sources of light (e.g., lasers), plates, films, beam splitters, lenses, and/or mirrors, among other components, arranged or configured in a particular manner to generate holographic content (e.g., holograms). The holographic display 370 can utilize principles of light physics to generate specific interference patterns within a given medium facilitating the generation of holographic content. In embodiments, components of the holographic display 370 can be reconfigurable (e.g., light characteristics emitted from light sources can be dynamically updated, mirror/lens position/orientation can be dynamically updated, etc.) such that holographic display content characteristics can be fine-tuned based on visibility data. The holographic display 370 can utilize any suitable medium for generating holographic content (e.g., foggy air versus clear air). The sensors 375 of the display device 355 can be configured to collect visibility data indicating visibility of the 2D display 365 with respect to one or more users.

Sensors 340 of user device 330, sensors 375 of display device 355, and/or IoT sensors 395 can include any suitable type of sensors indicating visibility conditions of the display device 355 with respect to one or more users. The sensors 340, 375, and/or 395 can include optical sensors such as cameras, fog detectors, visibility detectors, light sensors (e.g., phototransistors, photoresistors, photovoltaic light sensors), gaze trackers (e.g., eye-tracking cameras), smoke detectors, and chromameters, among others. Sensors 340, 375, and/or 395 can capture visibility data including the field of view (FoV) of users, the distance between the users and the 2D display 365, the level of visibility in the air (e.g., fog/dust/smoke concentration), obstructions blocking view of the 2D display 365, environmental light conditions (e.g., ambient light), and viewing angle, among other visibility data. The above sensor types are merely exemplary, and any suitable sensor data used to indicate visibility of the 2D display 365 can be collected without departing from the spirit and scope of the present disclosure.

The HDMS 305 includes a visibility monitoring module 310, a visibility analyzer 315, a holographic content characteristic determiner 320, and a holographic content generator 325. The visibility monitoring module 310, visibility analyzer 315, holographic content characteristic determiner 320, and holographic content generator 325 can be processor-executable instructions that can be executed by a dedicated or shared processor using received inputs.

The visibility monitoring module 310 can be configured to collect visibility data indicating visibility of the 2D display 365 of the display device 355 with respect to one or more users. The visibility monitoring module 310 can collect visibility data from tracking 342 and/or sensors 340, 375, and/or 395. The visibility monitoring module 310 can collect visibility data such as the field of view (FoV) of users, the distance between users and the 2D display 365, the level of visibility in the air (e.g., fog/dust concentration), obstructions blocking view of the 2D display 365, environmental light conditions (e.g., ambient light), and viewing angle, among other visibility data. As discussed above, various types of sensor data (e.g., optical sensor data) can be collected from tracking 342 and/or sensors 340, 375, and/or 395 to indicate the above examples of visibility data. The visibility monitoring module 310 can monitor visibility of the 2D display 365 of the display device 355 over any suitable time period (e.g., continuously, intermittently, periodically, etc.).

The visibility analyzer 315 can be configured to analyze the collected visibility data (e.g., obtained by visibility monitoring module 310) to determine whether there is low visibility (e.g., a low visibility condition, visibility below a threshold) of the 2D display 365 with respect to one or more users. The visibility data can be analyzed in any suitable manner. Analyzing the visibility data to determine low visibility can consider the field of view (FoV) of the user, the distance between the user and the 2D display 365, the level of visibility in the air (e.g., fog/dust concentration) nearby the user, obstructions blocking the user's view of the 2D display 365, light conditions in the environment of the user, and/or viewing angle of the user. In embodiments, one or more of the above visibility factors can be considered to determine a low visibility condition.

As a detailed example, visibility data can be collected to determine that the FoV of a first user includes the 2D display 365, the distance between the user and the 2D display 365 is 10 meters (relatively proximate), the visibility in the air is high (e.g., the air is clear), there are no obstructions blocking the user's view of the 2D display 365, environmental light is moderate (e.g., not too intense or dark), and the viewing angle is between 0-15° (e.g., where 0° is orthogonal to the surface of the 2D display 365 and thus readily viewable, and where 90° is parallel to the surface of the 2D display 365 and thus unviewable). In this example, as the user is relatively proximate to the 2D display 365 with great viewing conditions (e.g., clear air, no obstructions, moderate lighting, and a great viewing angle), then a determination can be made that visibility is acceptable (e.g., not low) by the visibility analyzer 315. However, in this example, if the distance between the user and the 2D display 265 was greater, if the visibility in the air was lower (e.g., foggy, dusty, or smoky), if there were obstructions (e.g., a tree or person) blocking the user's view of the 2D display 365, if the environmental light was too high or low, and/or if the viewing angle was poor (e.g., from 40°-90°), then a determination could be made that the visibility is low.

In embodiments, a single visibility factor (e.g., an obstruction, visibility in the air, viewing angle, distance) can be used to determine whether visibility is low. For example, if an obstruction is blocking the user's view of the display device 355, a determination can be made that visibility is low. As another example, if visibility in the air is low (e.g., there is high fog) then a determination can be made that visibility is low. As another example, if viewing angle of the user is poor (e.g., within a particular viewing angle range such as between 40°-90°), then a determination can be made that visibility is low. However, any suitable number and/or type of visibility data factors can be considered to determine whether visibility is acceptable or low.

In embodiments, AI/ML algorithms can utilize historical holographic display data 385 of datastore 380 to determine whether visibility is low based on current visibility data. The historical holographic display data 385 can indicate previous conditions when visibility was determined to be low and when holograms were generated to aid user view of display device 355. Thus, in embodiments, AI/ML algorithms can be trained based on historical holographic display data 385 which can indicate historical conditions in which visibility was determined to be low. The AI/ML algorithms can be trained to identify low visibility conditions based on historically collected visibility data over time. Any AI/ML algorithms discussed with respect to FIG. 2 can be configured to determine low visibility based on historically gleaned visibility insights. For example, the AI/ML algorithms can be trained via supervised or unsupervised machine learning.

The holographic content characteristic determiner 320 can be configured to determine holographic content characteristics of a hologram to be generated. The holographic content characteristic determiner 320 can be instructed to determine holographic content characteristics upon an indication of low visibility received from visibility analyzer 315. Holographic content characteristics that can be configurable include light physics characteristics (e.g., waveform characteristics facilitating generation of interference patterns on a physical medium), light intensity, hologram position, hologram orientation, hologram color, and hologram size. The holographic content generated by the holographic display 370 can mirror the content currently displayed by the 2D display 365 such that the user can view the content which was displayed on the 2D display 365 via generated holographic content during low visibility. Thus, the holographic content characteristics can alter the characteristics of the content which is mirrored from the 2D display 365 and projected mid-air via holography. The holographic content characteristics can be determined in any suitable manner.

In embodiments, the holographic content characteristics can be determined based on the holographic display 370 of the device. That is, if the holographic display 370 has limited functionality (e.g., is not reconfigurable or has limitations on hologram characteristics that can be generated), the holographic content characteristic determiner 320 can determine holographic content characteristics that can be rendered by the holographic display 370 to mirror the content displayed on the 2D display 365. For example, certain holographic displays 370 may have limitations on hologram size, hologram color, hologram position, hologram orientation, or mediums in which holograms can be projected. Thus, in embodiments, the holographic content characteristics can be determined based on the functionality of the holographic display 370.

In embodiments, the holographic content characteristics can be determined based on the visibility data. For example, the holographic content characteristic determiner 320 can determine holographic content characteristics based on the FoV of the user, the distance between the user and the 2D display 365, the level of visibility in the air in the environment of the user, obstructions to the user blocking view of the 2D display 365, light conditions in the environment of the user, and viewing angle of the user with respect to the 2D display 365. As such, the holographic content to be displayed can be personalized based on the user's point of view.

As an example, assuming a user's viewing angle is 45° with respect to the 2D display 365, then holographic content characteristics can be altered such that the position of the hologram is farther from the display device 355 and such that the orientation of the hologram is aligned with the user's viewing angle (e.g., the hologram protrudes further from the display device 355 and is rotated 45° towards the user). This can allow the user to see the hologram as if it is facing the user, even though the 2D display 365 is viewed from a 45° viewing angle. As another example, assume that the distance between the user and the 2D display 365 is large (e.g., 50 meters). In this example, the holographic content characteristics can be altered to increase the size and light intensity of the hologram to be generated such that the user can view the details of the hologram from the far viewing distance. As another example, assuming that the level of visibility in the air is low (e.g., there is high fog), then the light physics characteristics (e.g., waveform characteristics generated by the holographic display 370) can be modified in accordance with the visibility conditions based on the medium in which the hologram will be projected. This can include enhancing the hologram light intensity based on the visibility conditions. As another example, assuming that an obstruction is blocking the user from viewing the 2D display 365, then the holographic content characteristics can be altered to increase the distance that the hologram is projected from the display device 355 such that the user can view the hologram in light of the location of the obstruction. As another example, light physics characteristics and light intensity of holographic content to be displayed can depend on the environmental light in the vicinity of the display device 355. However, the above holographic content characteristic determinations based on visibility factors are merely exemplary, and any suitable holographic content characteristics can be determined based on current visibility data.

The magnitude that holographic content characteristics are altered can depend on the current visibility data. For example, for higher viewing angles between the user and the 2D display 365, the orientation of the hologram can be updated to mirror the viewing angle such that the hologram is oriented with the user's viewing angle (e.g., larger viewing angles can result in larger hologram orientation alterations). As another example, for larger distances between the user and the 2D display 365, the size of the hologram can be updated to be larger based on the distance (e.g., larger viewing distances can result in larger hologram sizes).

In embodiments, AI/ML algorithms can utilize historical holographic display data 385 of datastore 380 to determine holographic content characteristics based on current visibility data. The historical holographic display data 385 can indicate previous visibility conditions and resulting holographic content characteristics that were suitable for such visibility conditions. Thus, in embodiments, AI/ML algorithms can be trained based on historical holographic display data 385 which can indicate historical conditions in which holographic content characteristics were suitable in light of certain visibility conditions. The AI/ML algorithms can be trained to determine holographic content characteristics based on historically collected visibility data over time. Any of the AI/ML algorithms discussed with respect to FIG. 2 can be utilized to determine holographic content characteristics based on insights gleaned from historical holographic display data 385. The AI/ML algorithms can be trained via supervised or unsupervised machine learning.

Reference will now be made to individual visibility factors, their use in determining low visibility conditions by the visibility analyzer 315, and their use in determining holographic content characteristics by the holographic content characteristic determiner 320.

Field of View (FoV) of the user can indicate what the user can see in their visual field. FoV of the user can be determined based on data collected from sensors 340, 375, and/or 395 within network environment 300. In embodiments, determining whether visibility of the 2D display 365 is low by the visibility analyzer 315 can include determining that the FoV of the user does not include the 2D display. In embodiments, determining whether visibility of the 2D display 365 is low by the visibility analyzer 315 can include determining that the 2D display 365 is within a particular location within the FoV of the user (e.g., on the outer edge or peripheral of the user's FoV). FoV of the user can be used to determine various holographic content characteristics, such as the position of a hologram (e.g., how far the hologram protrudes from the 2D display 365), the orientation of the hologram (e.g., based on where the hologram is within the user's FoV), size of the hologram, light physics characteristics of the hologram, color of the hologram, and intensity of the hologram. For example, in response to determining a first FoV of the user, a first position of the hologram, a first orientation of the hologram, and a first size of the hologram can be determined. In response to determining a second FoV of the user, a second position of the hologram, a second orientation of the hologram, and a second size of the hologram can be determined.

The distance between the user and the 2D display 365 generally indicates how far the user is from the 2D display 365. The distance between the user and the 2D display 365 can be determined based on data collected from sensors 340, 375, and/or 395 within network environment 300. In embodiments, determining whether visibility of the 2D display 365 is low by the visibility analyzer 315 can include determining that the distance between the user and the 2D display 365 exceeds a threshold value (e.g., a threshold distance). Distance between the user and the 2D display 365 can be used to determine various holographic content characteristics, such as the position of a hologram (e.g., how far the hologram protrudes from the 2D display 365), size of the hologram, light physics characteristics of the hologram, color of the hologram, and intensity of the hologram. For example, in response to determining a first distance between the user and the 2D display 365, a first position of the hologram and a first intensity of the hologram can be determined. In response to determining a second distance between the user and the 2D display 365, a second position of the hologram and a second intensity of the hologram can be determined.

Level of visibility in the air (e.g., air particulate concentration, fog level, dust level, visibility level, etc.) generally indicates how clear the air is for viewing objects. The level of visibility in the air can be determined based on data collected from sensors 340, 375, and/or 395 within network environment 300. In embodiments, determining whether visibility of the 2D display 365 is low by the visibility analyzer 315 can include determining that the level of visibility in the air falls below a threshold visibility level (or exceeds a concentration/fogginess level). Level of visibility in the air can be used to determine various holographic content characteristics, such as the position of a hologram (e.g., how far the hologram protrudes from the 2D display 365), size of the hologram, light physics characteristics of the hologram, color of the hologram, and intensity of the hologram. For example, in response to determining a first visibility level in the air, a first set of light physics characteristics of the hologram can be determined, a first position of the hologram can be determined, and a first intensity of the hologram can be determined. In response to determining a second visibility level in the air, a second set of light physics characteristics of the hologram can be determined, a second position of the hologram can be determined, and a second intensity of the hologram can be determined.

Obstructions blocking the user's view of the 2D display 365 generally indicate objects (e.g., trees, people, signage, debris) blocking view of the 2D display 365. Obstructions blocking the user's view of the 2D display 365 can be determined based on data collected from sensors 340, 375, and/or 395 within network environment 300. In embodiments, determining whether visibility of the 2D display 365 is low by the visibility analyzer 315 can include determining that there are one or more obstructions blocking the user's view of the 2D display 365. Obstructions blocking the user's view of the 2D display be used to determine various holographic content characteristics, such as the position of a hologram (e.g., how far the hologram protrudes from the 2D display 365), size of the hologram, light physics characteristics of the hologram, and intensity of the hologram. For example, in response to determining that a first obstruction (e.g., a tree) is blocking the user's view of the 2D display 365, a first position and size of the hologram can be determined. In response to determining a second obstruction (e.g., a person) is blocking the user's view of the 2D display 365, a second position and size of the hologram can be determined. In embodiments, the holographic content characteristics (e.g., the position and size of the hologram) can depend on characteristics of the obstruction (e.g., the size and location of the obstruction with respect to the user's FoV).

Light conditions in the environment of the user generally indicate how bright or dark the environmental light is within the vicinity of the user attempting to view the 2D display 365. Light conditions in the environment of the user can be determined based on data collected from sensors 340, 375, and/or 395 within network environment 300. In embodiments, determining whether visibility of the 2D display 365 is low by the visibility analyzer 315 can include determining that light conditions exceed or fall below a threshold brightness value (e.g., a lumens per square foot value). Light conditions in the environment of the user can be used to determine various holographic content characteristics, such as the light physics characteristics of the hologram and intensity of the hologram. For example, in response to determining a first light condition value in the environment of the user, a first set of light physics characteristics and a first hologram intensity can be determined. In response to determining a second light condition value in the environment of the user, a second set of light physics characteristics and a second hologram intensity can be determined.

Viewing angle of the user indicates the angle at which the 2D display 365 is viewed with respect to the user. For example, a 0° viewing angle between a user and the 2D display 365 can indicate that the user is perpendicular to the surface of the 2D display 365 (e.g., the user is directly facing the 2D display 365), whereas a 90° viewing angle between the user and the 2D display 365 can indicate the user is parallel with the surface of the 2D display 365 (e.g., the user is viewing the 2D display 365 from the side, and thus likely cannot see any displayed content). Viewing angle of the user with respect to the 2D display 365 can be determined based on data collected from sensors 340, 375, and/or 395 within network environment 300. In embodiments, determining whether visibility of the 2D display 365 is low by the visibility analyzer 315 can include determining that viewing angle of the user with respect to the 2D display 365 is within a particular viewing angle range (e.g., 45°-90°) or exceeds a viewing angle threshold (e.g., exceeds 60°). Viewing angle of the user with respect to the 2D display 365 can be used to determine various holographic content characteristics, such as the light physics characteristics of the hologram, the orientation of the hologram, the position of the hologram, the size of the hologram, and the intensity of the hologram. For example, in response to determining a first viewing angle between the user and the 2D display 365, a first position and orientation of the hologram can be determined. In response to determining a second viewing angle between the user and the 2D display 365, a second position and orientation of the hologram can be determined.

The holographic content generator 325 can be configured to instruct the holographic display 370 to generate holographic content based on the determined holographic content characteristics. Thus, upon instruction from the holographic content generator 325, the holographic display 370 can project the content which is displayed on the 2D display 365 mid-air via holography. In embodiments, the content which is displayed on the 2D display 365 can continue to be displayed on the 2D display 365 (e.g., for other users that can see the 2D display). In embodiments, the content which was displayed on the 2D display 365 may no longer be displayed on the 2D display 365 upon projection via the holographic display 370. This can save power in situations where no other viewers require to see the 2D display 365 upon holographic projection.

It is noted that FIG. 3 is intended to depict the representative major components of an example computing environment 300. In some embodiments, however, individual components can have greater or lesser complexity than as represented in FIG. 3, components other than or in addition to those shown in FIG. 3 can be present, and the number, type, and configuration of such components can vary.

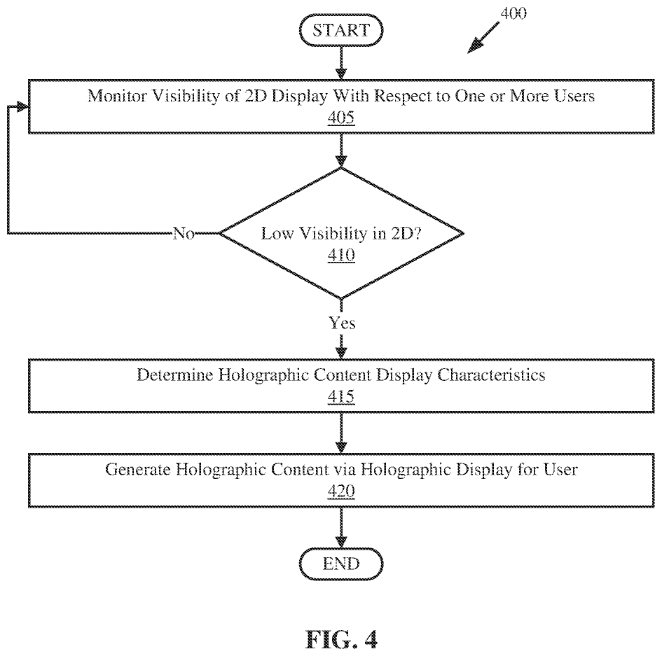

Referring now to FIG. 4, shown is a flow-diagram illustrating an example method 400 for holographic display management, in accordance with embodiments of the present disclosure. One or more operations of method 400 can be completed by one or more processing circuits (e.g., computer 101, devices 205, server 235, user device 330, display device 355, HDMS 305, IoT sensors 395).

Method 400 initiates at operation 405, where visibility of a 2D display is monitored with respect to one or more users. Monitoring visibility at operation 405 can be completed in the same, or a substantially similar manner, as described with respect to visibility monitoring module 310 of FIG. 3. For example, monitoring visibility can include collecting sensor data from one or more surrounding optical sensors.

A determination is made whether there is low visibility of the 2D display. This is illustrated at operation 410. Determining whether there is low visibility can be completed in the same, or a substantially similar manner, as described with respect to the visibility analyzer 315 of FIG. 3. For example, determining whether visibility is low can consider the field of view (FoV) of users, the distance between the users and the 2D digital display, the level of visibility in the air (e.g., fog/dust concentration), obstructions blocking view of the 2D digital display, environmental light conditions (e.g., ambient light), and viewing angle, among other visibility data/factors that can be collected at operation 405.

If a determination is made that there is not low visibility (there is acceptable visibility) of the 2D display (“No” at operation 410), then method 400 can return to operation 405 where visibility can continue to be monitored over any suitable time period (e.g., continuously, intermittently, periodically, etc.).

If a determination is made that there is low visibility of the 2D display (“Yes” at operation 410), then holographic content display characteristics of a hologram to be generated can be determined. The holographic content display characteristics can be determined in the same, or a substantially similar manner, as described with respect to the holographic content characteristic determiner 320 of FIG. 3. For example, holographic display characteristics such as light physics characteristics (e.g., waveform characteristics facilitating generation of interference patterns on a physical medium), light intensity, hologram position, hologram orientation, hologram color, and hologram size can be determined based on visibility data such as FoV of the user, the distance between the user and the 2D display, the level of visibility in the air in the environment of the user, obstructions to the user blocking view of the 2D display, light conditions in the environment of the user, and viewing angle of the user with respect to the 2D display.

The holographic content is then generated via a holographic display for the user. This is illustrated at operation 420. The holographic content can mirror the content which is displayed on the 2D display. The holographic content can have holographic content characteristics determined at operation 415. In embodiments, a command can be issued to a holographic projector/display to cause display of the holographic content to mirror the content displayed on the 2D display having the holographic content characteristics determined at operation 415.

The aforementioned operations can be completed in any order and are not limited to those described. Additionally, some, all, or none of the aforementioned operations can be completed, while still remaining within the spirit and scope of the present disclosure.

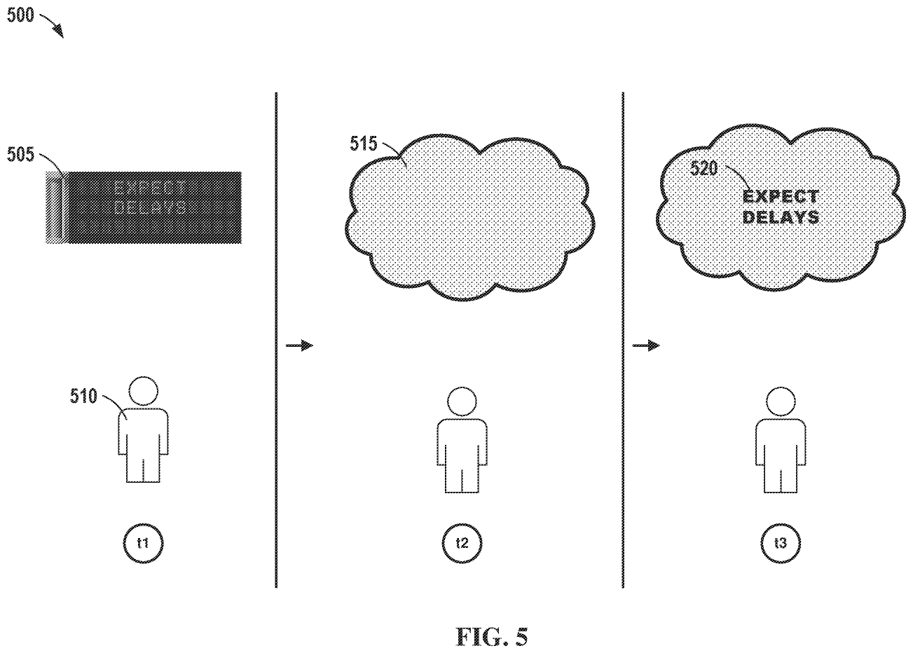

Referring now to FIG. 5, shown is an example scenario 500 in which holographic display management can be implemented, in accordance with embodiments of the present disclosure.

As shown in scenario 500, a 2D display 505 in the form of traffic signage displays content in 2D, “EXPECT DELAYS.” At a first time, t1, a user 510 can view the 2D display 505 with acceptable visibility. However, at a second time, t2, the user 510 can no longer view the 2D display 505 due to low visibility conditions in the air, depicted as fog 515. In this instance, the 2D displayed content may be important for viewing (e.g., relates to safety and is time-sensitive). Thus, holographic projection of the content displayed in 2D on the 2D display 505 can be completed at a third time, t3, such that the user can resume view of the content displayed in 2D. As such, holographic projection of the content displayed in 2D, “EXPECT DELAYS,” is completed onto the medium (fog 515) in the environment of the 2D display 505. Thus, at the third time, t3, the user can continue viewing the content displayed in 2D at the first time, t1. The above example of holographic display management is merely exemplary and is simplified for the purpose of understanding aspects of the present disclosure.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to those skilled in the art. Therefore, it is intended that the following claims be interpreted as covering all such alterations and modifications as fall within the true spirit and scope of the disclosure.

What is claimed is:

1. A method comprising:
detecting low visibility of a 2-dimensional (2D) display with respect to a user;
determining, in response to detecting the low visibility, holographic content display characteristics of holographic content to be generated from the 2D display; and
generating, based on the determined holographic content display characteristics, holographic content via a holographic display of the 2D digital display.

2. The method of claim 1, wherein detecting low visibility of the 2D display with respect to the user includes:
determining that an obstruction is blocking view of the 2D display with respect to the user based on collected sensor data.

3. The method of claim 2, wherein determining holographic content display characteristics of holographic content to be generated from the 2D display includes:
determining a distance that the holographic content will be projected from the holographic display based on a location of the obstruction.

4. The method of claim 1, wherein detecting low visibility of the 2D display with respect to the user includes:
determining that a viewing angle of the user with respect to the 2D display is within a viewing angle range based on collected sensor data.

5. The method of claim 4, wherein determining holographic content display characteristics of holographic content to be generated from the 2D display includes:
determining an orientation of the holographic content to be generated based on the viewing angle of the user with respect to the 2D display.

6. The method of claim 1, wherein detecting low visibility of the 2D display with respect to the user includes:
determining that a level of visibility in an environment of the 2D display is within a level of visibility range.

7. The method of claim 6, wherein determining holographic content display characteristics of holographic content to be generated from the 2D display includes:
determining light physics properties of the holographic content to be generated based on the determined level of visibility in the environment of the 2D display.

8. The method of claim 1, wherein holographic content display characteristics include at least one selected from a group consisting of:
holographic content light intensity, holographic content position, holographic content orientation, holographic content color, and holographic content size.

9. A system comprising:
one or more processors; and
one or more computer-readable storage media collectively storing program instructions which, when executed by the one or more processors, are configured to cause the one or more processors to perform a method comprising:
detecting low visibility of a 2-dimensional (2D) display with respect to a user;
determining, in response to detecting the low visibility, holographic content display characteristics of holographic content to be generated from the 2D display; and
generating, based on the determined holographic content display characteristics, holographic content via a holographic display of the 2D digital display.

10. The system of claim 9, wherein detecting low visibility of the 2D display with respect to the user includes:
determining that an obstruction is blocking view of the 2D display with respect to the user based on collected sensor data.

11. The system of claim 10, wherein determining holographic content display characteristics of holographic content to be generated from the 2D display includes:
determining a distance that the holographic content will be projected from the holographic display based on a location of the obstruction.

12. The system of claim 9, wherein detecting low visibility of the 2D display with respect to the user includes:
determining that a field of view (FoV) of the user does not include the 2D display based on collected sensor data.

13. The system of claim 12, wherein determining holographic content display characteristics of holographic content to be generated from the 2D display includes:
determining a position and a size of the holographic content to be generated based on the determination that the FoV of the user does not include the 2D display.

14. The system of claim 9, wherein detecting low visibility of the 2D display with respect to the user includes:
determining that a level of visibility in an environment of the 2D display is within a level of visibility range.

15. The system of claim 14, wherein determining holographic content display characteristics of holographic content to be generated from the 2D display includes:
determining light intensity of the holographic content to be generated based on the determined level of visibility in the environment of the 2D display.

16. A computer program product comprising one or more computer readable storage media, and program instructions collectively stored on the one or more computer readable storage media, the program instructions comprising instructions configured to cause one or more processors to perform a method comprising:
detecting low visibility of a 2-dimensional (2D) display with respect to a user;
determining, in response to detecting the low visibility, holographic content display characteristics of holographic content to be generated from the 2D display; and
generating, based on the determined holographic content display characteristics, holographic content via a holographic display of the 2D digital display.

17. The computer program product of claim 16, wherein detecting low visibility of the 2D display with respect to the user includes:
determining that environmental light in a vicinity of the 2D display is within a particular environmental light value range based on collected sensor data.

18. The computer program product of claim 17, wherein determining holographic content display characteristics of holographic content to be generated from the 2D display includes:
determining light intensity of the holographic content that will be projected from the holographic display based on the determined environmental light.

19. The computer program product of claim 16, wherein detecting low visibility of the 2D display with respect to the user includes:
determining that a distance between the user and the 2D display exceeds a threshold distance based on collected sensor data.

20. The computer program product of claim 19, wherein determining holographic content display characteristics of holographic content to be generated from the 2D display includes:
determining a size of the holographic content that will be projected from the holographic display based on the determination that the distance between the user and the 2D display exceeds the threshold distance.
